(19) United States
(12) Patent Application Publication
(10) Pub. No.: US 2026/0237298 A1
(43) Pub. Date: Aug. 13, 2026

(54) SYSTEM FOR PREVENTING SIMULTANEOUS VEHICLE ARRIVAL SITUATIONS AT INTERSECTIONS

(71) Applicant: Toyota Motor Engineering & Manufacturing North America, Inc., Plano, TX (US)

(72) Inventors: Benjamin Piya Austin, Saline, MI (US); Heishiro Toyoda, Mountain View, CA (US); Joshua E. Domeyer, Ypsilanti, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/049,399

(22) Filed: Feb. 10, 2025

(51) Int. Cl. G08G 1/0967; G08G 1/01

(52) U.S. Cl. CPC G08G 1/096725; G08G 1/0112; G08G 1/0133; G08G 1/0145

(57) ABSTRACT

A vehicle control system is configured to control operation of a main vehicle so that the main vehicle stops near an intersection non-simultaneously with all intersecting vehicles. The system estimates a time of arrival (ETA) of at least one other vehicle(s) at the intersection. Based on the at least one other vehicle(s) ETA, the system controls operation of the main vehicle so that the main vehicle arrives at its stop location a predetermined amount of time either before or after the at least one other vehicle(s) arrives at its stop location. The predetermined amount of time is specified so as to establish a sequence of arrival of vehicles at the intersection that is readily perceivable to a human driver of the at least one other vehicle(s), so that the order in which the vehicle(s) should proceed through the intersection is clear to any human drivers.

### TECHNICAL FIELD

The subject matter described herein relates to vehicle control systems and, more particularly, to a vehicle control system configured to control operation of a vehicle approaching an intersection so that it stops at the intersection either before or after one or more other vehicle(s) approaching the intersection.

### BACKGROUND

It is common for vehicles stopped at an intersection to proceed through the intersection in the order in which they arrived and stopped at the intersection. Frequently, however, there is confusion regarding the order in which the vehicles are to proceed through the intersection, due to confusion regarding the order in which the vehicles stopped at the intersection. This may be due to multiple vehicles arriving simultaneously or so close to each other in time that it can be difficult for a human driver to distinguish which arrived before another vehicle. This problem may be exacerbated when one or more autonomously-driven vehicle(s) stop at an intersection simultaneously or near-simultaneously with the arrival of vehicle(s) controlled by human drivers.

### SUMMARY

In one aspect of the embodiments described herein, a vehicle control system is provided including a processor and a memory communicably coupled to the processor and storing an intersection management module including computer-readable instructions that when executed by the processor cause the processor to control operation of a main vehicle so that the main vehicle stops near an intersection non-simultaneously with all intersecting vehicles.

In another aspect of the embodiments described herein, a method for controlling operation of a main vehicle is provided. The method includes a step of controlling operation of the main vehicle while approaching an intersection so that the main vehicle stops near the intersection non-simultaneously with all intersecting vehicles.

In another aspect of the embodiments described herein, a non-transitory computer-readable medium is provided for controlling operation of a main vehicle. The computer-readable medium stores instructions that when executed by a processor cause the processor to control operation of the main vehicle while approaching an intersection so that the main vehicle stops near the intersection non-simultaneously with all intersecting vehicles.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale. Additionally, it will be appreciated that for simplicity and clarity of illustration, where appropriate, reference numerals may have been repeated among the different figures to indicate corresponding or analogous elements.

FIG. 1 is a block schematic diagram of a vehicle incorporating elements of a vehicle control system including an intersection management module in accordance with embodiments described herein.

FIG. 2 is a schematic plan view of an intersection of two orthogonally-extending roads, with multiple intersecting vehicles approaching an intersection of the roads.

FIG. 3 is a schematic representation of one example of a vehicle velocity curve usable for autonomously controlling motion of a vehicle from a stop at one location to a stop at another location.

FIG. 4 is a flow diagram illustrating a sequence of events causing activation of an intersection management protocol to be implemented by an intersection management module in accordance with embodiments described herein.

FIG. 5 is a is a flow diagram illustrating one example of a process for estimating and/or determining values of parameters used for controlling an estimated time of arrival (ETA) of a main vehicle at an intersection in relation to ETAs of intersecting vehicles also approaching the intersection.

FIG. 6 is a flow diagram illustrating a process for determining an ETA for each intersecting vehicle detected by sensors of the main vehicle, and for updating the ETA of each vehicle.

FIG. 6A is a flow diagram illustrating estimation a number of occupants in each intersecting vehicle.

FIG. 7 is a flow diagram illustrating a process for controlling an estimated time of arrival (ETA) of a main vehicle at its stop location in relation to ETAs of intersecting vehicles also approaching their respective stop locations, in accordance with embodiments described herein.

FIG. 7A is a flow diagram illustrating association of each intersecting vehicle containing at least a minimum number of occupants (or more than a specific number of occupants) with its respective ETA.

FIG. 7B is a flow diagram illustrating one mode of controlling a main vehicle responsive to a determination that an emergency condition exists in an intersecting vehicle.

FIG. 8 is a schematic representation of a timeline illustrating possible relative estimated arrival times of a main vehicle with respect to an estimated arrival time of each intersecting vehicle of multiple intersecting vehicles, when the estimated arrival time of the main vehicle is controlled responsive to the estimated arrival times of the intersecting vehicles.

### DETAILED DESCRIPTION

Embodiments described herein relate to a vehicle control system including a processor and a memory communicably coupled to the processor and storing an intersection management module including computer-readable instructions that when executed by the processor cause the processor to control operation of a main vehicle so that the main vehicle stops near an intersection non-simultaneously with all intersecting vehicles. The system detects that a main vehicle is approaching the intersection. The system also detects that at least one other vehicle is approaching the intersection simultaneously with the main vehicle, but from another direction. The system estimates stop locations of the main vehicle and the at least one other vehicle(s) at the intersection. The system estimates a time of arrival (ETA) of the at least one other vehicle(s) at its stop location(s). Based on the at least one other vehicle(s) ETA, the system controls operation of the main vehicle so that the main vehicle arrives at its stop location a predetermined amount of time either before or after the at least one other vehicle(s). The predetermined amount of time is specified so as to establish a sequence of arrival of vehicles at the intersection that is readily perceivable to a human driver of the at least one other vehicle(s), so that the order in which the vehicle(s) should proceed through the intersection is clear to any human drivers.

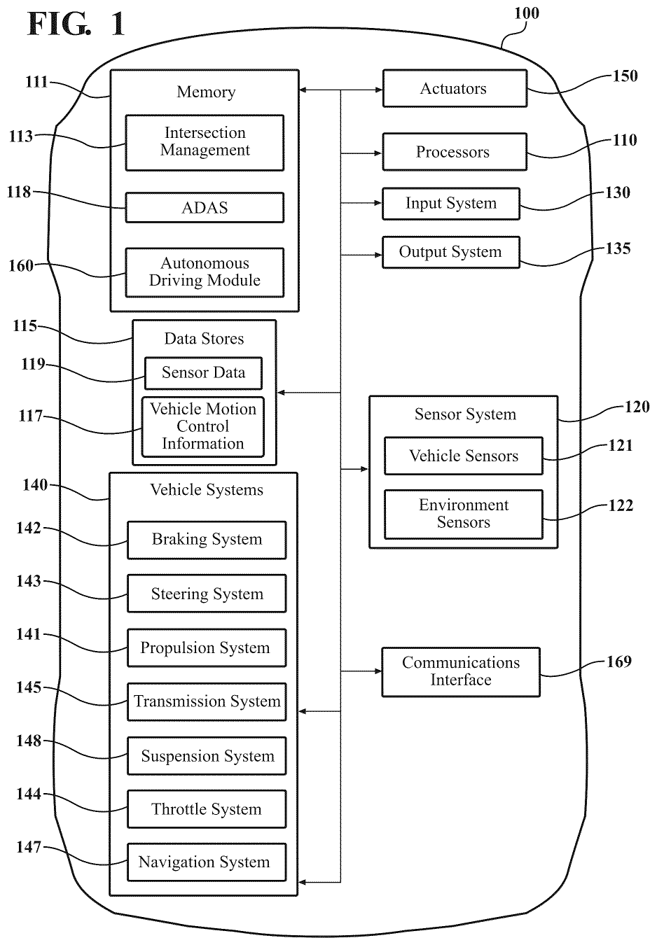

FIG. 1 is a block schematic diagram of a main vehicle 100 incorporating elements of a vehicle control system including an intersection management module 113 in accordance with embodiments described herein. As used herein, a “vehicle” is any form of motorized transport. In one or more implementations, the main vehicle 100 is passenger vehicle such as a sedan. While arrangements will be described herein with respect to passenger vehicles, it will be understood that embodiments are not limited to conventional passenger vehicles. In some implementations, the main vehicle 100 may be any form of motorized transport that may benefit from the functionality discussed herein.

The main vehicle 100 also includes various elements. Some of the possible elements of the main vehicle 100 are shown in FIG. 1 and will be described with reference thereto. It will be understood that in various embodiments it may not be necessary for the main vehicle 100 to have all of the elements shown in FIG. 1. The main vehicle 100 can have any combination of the various elements shown in FIG. 1. Further, the main vehicle 100 can have additional elements to those shown in FIG. 1. In some arrangements, the main vehicle 100 may be implemented without one or more of the elements shown in FIG. 1. While the various elements are shown as being located within the main vehicle 100 in FIG. 1, it will be understood that one or more of these elements can be located external to the main vehicle 100. Further, the elements shown may be physically separated by large distances. In addition, the discussion outlines numerous specific details to provide a thorough understanding of the embodiments described herein. Those of skill in the art, however, will understand that the embodiments described herein may be practiced using various combinations of these elements.

In some instances, the main vehicle 100 may be configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from a user (e.g., human driver). In one or more arrangements, the main vehicle 100 can be a conventional vehicle that is configured to operate in only a manual mode.

In one or more embodiments, the main vehicle 100 is an autonomous vehicle. As used herein, “autonomous vehicle” refers to a vehicle that can operate in an autonomous mode. “Autonomous mode” refers to navigating and/or maneuvering the main vehicle 100 along a travel route using one or more computing systems to control the main vehicle 100 with minimal or no input from a human driver. In one or more embodiments, the main vehicle 100 is highly automated or completely automated. In one embodiment, the main vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the main vehicle 100 along a travel route. In particular arrangements, the main vehicle 100 is configured with one or more operational modes in which the vehicle is autonomously controlled by intersection management module 113 to implement an embodiment of an intersection management protocol as described herein.

The main vehicle 100 can include one or more processors 110. In one or more arrangements, the processor(s) 110 can be a main processor(s) of the main vehicle 100. For instance, the processor(s) 110 can be an electronic control unit (ECU). The main vehicle 100 can include one or more data store(s) 115 for storing one or more types of data. The data store(s) 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 115 can be a component of the processor(s) 110, or the data store(s) 115 can be operably connected to the processor(s) 110 for use thereby. The term “operably connected,” as used throughout this description, can include direct or indirect connections, including connections without direct physical contact.

The one or more data stores 115 can include sensor data 119. In this context, “sensor data” means any information about the sensors that the main vehicle 100 is equipped with, including the capabilities and other information about such sensors. As will be explained below, the main vehicle 100 can include the sensor system 120. The sensor data 119 can relate to one or more sensors of the sensor system 120. As an example, in one or more arrangements, the sensor data 119 can include information on one or more vehicle sensors 121 of the sensor system 120.

The one or more data stores 115 can include vehicle motion control information 117. In this context, “vehicle motion control information” may include curves, formulae, functions, lookup tables and/or any other information suitable or pertinent for control of vehicle velocity, acceleration, braking and/or other motion-related vehicle parameters by the autonomous driving module 160 and/or the intersection management module 113.

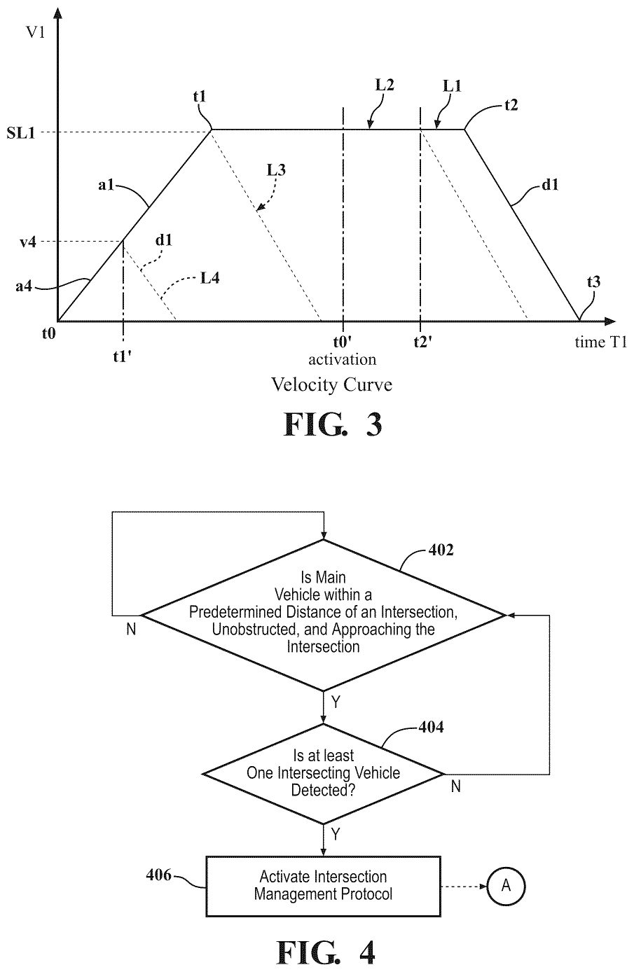

In arrangements described herein, aspects of the vehicle motion control information 117 may define maximum and minimum safe and/or comfortable acceleration rates (i.e., rates of increase of vehicle velocity) and deceleration rates (i.e., rates of decrease of vehicle velocity) under various conditions. Aspects of the vehicle motion control information 117 may define points during movement of the main vehicle 100 at which acceleration ends and deceleration begins. A length of time the main vehicle 100 has to accelerate, travel at a given speed and decelerate may depend on the estimated distance the vehicle is to travel from a given location to its stop location near an intersection. For example, FIG. 3 is a schematic diagram showing an example of a vehicle velocity curve usable for autonomously controlling motion of a vehicle from a stop at one location to a stop at another location. Referring to FIG. 3, for a distance L1 between stops, movement of a vehicle may be controlled to accelerate at rate a1 from a stopped condition (velocity V1=0) at time=t0 to a constant velocity (e.g., a speed limit SL1 of the road along which the vehicle is traveling) at time=t1. The vehicle may then be controlled to travel at speed limit SL1 from t1 to t2. The vehicle may then be controlled to decelerate at rate d1 from time=t2 to time=t3 as the vehicle reaches its stop location.

In another scenario, for traveling a relatively shorter distance L2 between stops, the vehicle may begin to decelerate from the constant velocity relatively sooner (at time=t2′). In some scenarios, where an even shorter distance is traveled between stops, the main vehicle 100 may begin to decelerate from the constant velocity even sooner (at time=t1, as soon as the speed limit SL1 is reached). In some even shorter-distance scenarios (e.g. travel distance from start to stop=L4), the main vehicle 100 may begin to decelerate as soon as a lower velocity v4 is reached.

In one or more arrangements, the acceleration rate a1 and deceleration rate d1 may be the most rapid acceleration and deceleration rates advisable for occupant comfort and/or safety, and for a given set of driving conditions. In one or more arrangements, the velocity SL1 may be the maximum legal speed limit of the main vehicle 100 along portion of road currently being traveled. Use of maximum allowable values for these parameters may enable the vehicle to be controlled so that it reaches an intersection in the shortest feasible amount of time.

The vehicle motion control information 117 may be determined and compiled for numerous scenarios depending on values of various pertinent parameters, including estimated distance to be traveled between stops, estimated distance to a stop location when the vehicle is already moving, legal minimum and/or maximum allowable speed limits on the road (sensors, GPS info), an estimated required stopping distance for the main vehicle at given speed and deceleration rate, and other parameters. For example, velocity curves and other control specifications may be determined for icy road conditions and low visibility conditions. For such conditions, parameters such as maximum allowable vehicle speed, acceleration rate and deceleration rate may be adjusted depending on data from vehicle and/or environment sensors. the maximum allowable speeds, acceleration rates, deceleration rates and estimated required stopping distances for the main vehicle may depend on road conditions, mechanical conditions of the vehicle tires, mechanical conditions of braking system (including brakes), vehicle response characteristics (e.g., acceleration the vehicle can develop in response to operation of throttle controls, the dynamic response of the braking system during actuation, etc.) and other pertinent factors. The vehicle sensors 121 and environment sensors 122 may include sensors configured to determine or estimate values of parameters relevant to controlling vehicle motion.

Velocity curves similar to the curve shown in FIG. 3 and other vehicle motion control information may be determined analytically and/or by experimentation and stored in vehicle motion control information 117 in data stores 115. In some arrangements, the intersection management module 113 may be configured to interpolate and/or generating new velocity curves (i.e. curves not explicitly stored) by processing the values of pertinent control parameters in a given situation, based on sensor data, GPS data and/or any other available sources.

As noted above, the main vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such case, the two or more sensors can form a sensor network. The sensor system 120 and/or the one or more sensors can be operably connected to the processor(s) 110, the data store(s) 115, and/or another element of the main vehicle 100 (including any of the elements shown in FIG. 1). The sensor system 120 can include any suitable type of sensor. Various examples of different types of sensors will be described herein. However, it will be understood that the embodiments are not limited to the particular sensors described.

Various examples of sensors of the sensor system 120 are described herein. The example sensors may be part of the one or more environment sensors 122 or the one or more vehicle sensors 121. However, it will be understood that the embodiments are not limited to the particular sensors described. The sensor system 120 may include any sensors suitable for and/or required to perform any of the data acquisition and/or vehicle control operations contemplated herein. As an example, in one or more arrangements, the environment sensors 122 can include one or more radar sensors, one or more LIDAR sensors, one or more sonar sensors, and/or one or more exterior cameras. In one or more arrangements, the one or more cameras can be high dynamic range (HDR) cameras or infrared (IR) cameras.

As used herein, “acquire” means to obtain by any means. For example, information may be acquired by the intersection management module 113 responsive to a direct request generated by the module. In addition, information may be acquired by the intersection management module 113 by the module receiving information responsive to a standing instruction to forward such information to the module or to a memory in operable communication with the module. Similarly, information may be acquired or obtained by vehicle and environment sensors 121,122 either passively (e.g., through receipt of images by a camera) or actively (by radar scans of the vehicle external environment). Sensors of the sensor system 120 may be configured to operate at sampling rates suitable for acquiring and updating data and/or other information relating to determination and/or estimation of values of the parameters described herein as being relevant for controlling operation of the main vehicle 100. In particular arrangements, any of the sensors of sensor system 120 may be configured to operate at a sampling rate of up to 100 Hz as required for a given type of data or information to be acquired by the sensors.

The sensor system 120 can include one or more vehicle sensors 121. The vehicle sensor(s) 121 can detect, determine, and/or sense information about the main vehicle 100 itself. In one or more arrangements, the vehicle sensor(s) 121 can be configured to detect, and/or sense position and orientation changes of the main vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the main vehicle 100, such as the current geographical location of the vehicle. In one or more arrangements, the vehicle sensor(s) 121 can include a speedometer to determine a current speed of the main vehicle 100. The vehicle sensor(s) 121 may include vehicle directional sensors configured to determine a current heading of the vehicle or direction in which the vehicle is pointed. In some arrangements, the vehicle sensor(s) 121 can include sensors for estimating or determining characteristics such as vehicle brake conditions, tire conditions, and the conditions of other vehicle components and/or systems pertinent to effective and precise control of vehicle motion.

The sensor system 120 can include one or more environment sensors 122 configured to acquire, and/or sense driving environment data. “Driving environment data” includes data or information about the external environment in which the vehicle is located or one or more portions thereof. For example, the one or more environment sensors 122 can be configured to detect, quantify and/or sense obstacles in at least a portion of the external environment of the main vehicle 100 and/or information/data about such obstacles. Such obstacles may be stationary objects and/or dynamic objects.

In one or more arrangements described herein, the environment sensors 122 can be configured to determine the existence of conditions described herein and/or to determine or estimate (and/or to acquire data and other information usable for determining or estimating) values of one or more of the parameters described herein as being relevant for controlling operation of the main vehicle 100 so that the main vehicle stops near the intersection non-simultaneously with all intersecting vehicles.

The one or more environment sensors 122 can be configured to detect, measure, quantify and/or sense other things in the external environment of the main vehicle 100, such as, for example, lane markers, signs, traffic lights, traffic signs, lane lines, stop lines near intersections, crosswalks, curbs proximate the main vehicle 100, off-road objects, weather conditions, etc. In some arrangements, the one or more environment sensors 122 can be configured to read license plates of intersecting vehicles, to determine associated plate numbers.

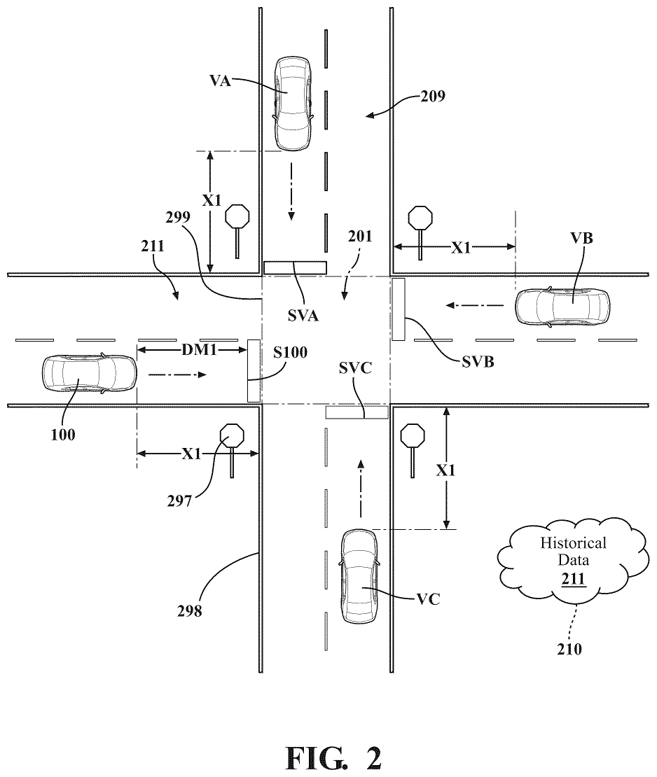

FIG. 2 is a schematic plan view of an intersection of two orthogonally-extending roads 209 and 211, with multiple vehicles 100, VA, VB and VC approaching an intersection 201 of the roads. The example shown in FIG. 2 includes three intersecting vehicles (VA, VB and VC) approaching the intersection 201.

As used herein, “intersecting vehicles” are defined as any vehicles other than the main vehicle 100 that are within a predetermined distance X1 of the intersection, are unobstructed, and are approaching the intersection from a direction different from the direction from which the main vehicle is approaching the intersection. A vehicle may be within a predetermined distance X1 of the intersection when the vehicle is within a distance X1 from a boundary of the intersection closest to the vehicle. Any vehicle (including main vehicle 100) is considered to be “unobstructed” when there is no obstacle to movement (e.g., other vehicles, pedestrians, cyclists, animals, etc.) detected between the vehicle and the intersection. Thus, when unobstructed, the vehicle may move freely between its current location and the intersection.

In one or more arrangements, the environment sensors 122 are configured to detect the presence and boundaries of an intersection 201 which the main vehicle 100 is currently approaching or facing toward. For purposes described herein, an “intersection” is a junction where two or more roads or streets converge, diverge, meet or cross at the same height, and which may be approached by multiple vehicles simultaneously from different directions. The intersection is an area from which vehicles are to be excluded while they are stopped near the intersection (for example, because of a stop sign or a stop line on the road, or because a vehicle is waiting for another vehicle to proceed through the intersection). One example of an intersection is a conventional “four-way stop” (including stop signs 297) shown in FIG. 2 as intersection 201. The intersection 201 is a rectangular area shown bounded by phantom lines connecting curbs extending along opposite sides of a respective road. In some arrangements, as shown in FIG. 2, boundaries of intersections may be defined by virtual lines extending from curbs or edges of roads (such as line 299 extending from curb 298).

In one or more arrangements, the environment sensors 122 are configured to estimate a distance of the main vehicle 100 to an intersection toward the main vehicle 100 is moving. In one or more arrangements, the environment sensors 122 are configured to detect the presence of other roads (such as road 209) intersecting at the intersection 201 (i.e., “intersecting roads”).

In one or more arrangements, the environment sensors 122 are configured to detect the speed of the main vehicle 100 when traveling toward the intersection 201. The environment sensors 122 may be configured to detect obstacles to movement of the main vehicle 100 and any intersecting vehicles, and to determine or estimate distances from the main vehicle 100 to features detected in the environment. The environment sensors 122 may be configured to detect non-obstructing objects (both static and moving) (i.e., objects that do not constitute an obstacle to movement of the main vehicle 100 toward the intersection) in the vehicle external environment. Non-obstructing objects may reside, for example, on the road outside the path of the main vehicle or along a side of the road. The environment sensors 122 may be configured to determine or estimate when the main vehicle 100 is within a predetermined distance X1 of the intersection 201. In one or more arrangements, the environment sensors 122 are configured to determine or estimate a distance DM1 of the main vehicle 100 from its determined stop location S100.

In one or more arrangements, the environment sensors 122 are configured to detect other vehicles including intersecting vehicles (both static and moving) in the external environment of vehicle 100. In one or more arrangements, the environment sensors 122 are configured to determine or estimate the respective speeds of any detected intersecting vehicles. The environment sensors 122 may be configured to determine or estimate directions of movement of detected intersecting vehicles with respect to the intersection 201. The environment sensors 122 may be configured to determine when any intersecting vehicle is currently stopped or static on its respective portion of a road.

In one or more arrangements, the environment sensors 122 are configured to determine or estimate distances of any detected intersecting vehicles from their respective estimated stop locations. The environment sensors 122 may be configured to determine or estimate when an intersecting vehicle is within a predetermined distance X1 of the intersection 201. The distance X1 may be specified so as to facilitate rapid acquisition of sufficient sensor data to enable determination and/or estimation of the intersecting vehicle stop location(s), speed(s), and distance(s) of the intersecting vehicle(s) from their respective stop location(s) when the intersecting vehicle(s) are detected by the sensor system 120.

The main vehicle 100 can include an input system 130. An “input system” includes any device, component, system, element or arrangement or groups thereof that enable information/data to be entered into a machine. For example, the input system 130 may include a keypad, a touch screen or other interactive display, a voice-recognition system and/or any other device or system which facilitates communications between a user and the vehicle. The input system 130 can receive an input from a vehicle occupant (e.g., a driver or a passenger) or a user located remotely from the main vehicle 100. The main vehicle 100 can also include an output system 135. An “output system” includes any device, component, or arrangement or groups thereof that enable information/data to be presented to a vehicle occupant (e.g., a person, a vehicle passenger, etc.) or a remote user.

The main vehicle 100 can include one or more vehicle systems, collectively designated 140. Various examples of the one or more vehicle systems 140 are shown in FIG. 1. However, the main vehicle 100 can include more, fewer, or different vehicle systems. It should be appreciated that although particular vehicle systems are separately defined, each or any of the systems or portions thereof may be otherwise combined or segregated via hardware and/or software within the main vehicle 100. The vehicle systems 140 can include a propulsion system 141, a braking system 142, a steering system 143, throttle system 144, a suspension system 148, a transmission system 145, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the main vehicle 100 and/or to determine a travel route for the main vehicle 100. The navigation system 147 can include one or more mapping applications to determine a travel route for the main vehicle 100. The navigation system 147 can include a global positioning system, a local positioning system or a geolocation system. The navigation system 147 may be configured to operate in conjunction with the autonomous driving module to guide the vehicle along a planned route.

The main vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110, the autonomous driving module(s) 160, and/or the intersection management module 113. Any suitable actuator can be used. For instance, the one or more actuators 150 can include motors, pneumatic actuators, hydraulic pistons, relays, solenoids, and/or piezoelectric actuators, just to name a few possibilities.

The main vehicle 100 can include one or more modules, at least some of which are described herein. The modules can be implemented as computer-readable program code that, when executed by processor(s) 110, implement one or more of the various processes described herein. One or more of the modules can be a component of the processor(s) 110, or one or more of the modules can be executed on and/or distributed among other processing systems to which the processor(s) 110 is operably connected. The modules can include instructions (e.g., program logic) executable by one or more processor(s) 110. Alternatively, or in addition, one or more of data store(s) 115 may contain such instructions.

Generally, a module as used herein includes routines, programs, objects, components, data structures, and so on that perform particular tasks or implement particular data types. In further aspects, a memory (such as memory 111) generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The main vehicle 100 can include one or more autonomous driving modules 160. The autonomous driving module(s) 160 can be configured to receive data from the sensor system 120 and/or any other type of system capable of capturing information relating to the main vehicle 100 and/or the external environment of the main vehicle 100. The autonomous driving module(s) 160 can determine position and velocity of the main vehicle 100. The autonomous driving module(s) 160 can determine the location of obstacles, obstacles, or other environmental features including traffic signs, trees, shrubs, neighboring vehicles, pedestrians, etc. The autonomous driving module(s) 160 can be configured to receive, and/or determine location information for obstacles within the external environment of the main vehicle 100 for use by the processor(s) 110, and/or one or more of the modules described herein to estimate position and orientation of the main vehicle 100, vehicle position in global coordinates based on signals from a plurality of satellites, or any other data and/or signals that could be used to determine the current state of the main vehicle 100 or determine the position of the main vehicle 100 with respect to its environment for use in either creating a map or determining the position of the main vehicle 100 in respect to map data. The autonomous driving module(s) 160 may be configured to autonomously control the user vehicle so as to drive the vehicle to a selected destination.

The autonomous driving module(s) 160 can be configured to determine travel path(s), current autonomous driving maneuvers for the main vehicle 100, future autonomous driving maneuvers and/or modifications to current autonomous driving maneuvers based on data acquired by the sensor system 120 and/or information received from a navigation system, such as navigation system 147. “Driving maneuver” means one or more actions that affect the movement of a vehicle. Examples of driving maneuvers include: accelerating, decelerating, braking, turning, moving in a lateral direction of the main vehicle 100, changing travel lanes, merging into a travel lane, and/or reversing, just to name a few possibilities. The autonomous driving module(s) 160 can be configured can be configured to implement determined driving maneuvers. The autonomous driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving module(s) 160 can be configured to execute various vehicle functions and/or to transmit data to, receive data from, interact with, and/or control the main vehicle 100 or one or more systems thereof (e.g., one or more of vehicle systems 140).

The main vehicle 100 can include an ADAS (Advanced Driver Assistance System) including an ADAS module 118 configured for controlling the ADAS system. As is known the pertinent art, the ADAS module 118 may use sensors and other technologies to detect obstacles, driver errors, and other hazards and to monitor the vehicle's surroundings. The ADAS system may then alert the driver to potential hazards using elements of the vehicle output system 135. Functions of the ADAS system may include adaptive cruise control, automatic emergency braking, lane departure warning and correction, blind spot detection and pedestrian detection and avoidance. The ADS system may incorporate a road sign assist (RSA) function to help drivers avoid missing signs, especially in bad weather.

The main vehicle 100 can include an intersection management module 113. With regard to the following discussion of the capabilities and operation of the intersection management module 113:
VA=a first intersecting vehicle
VB=a second intersecting vehicle
VC=a third intersecting vehicle
SVA=stop location of intersecting vehicle A
SVB=stop location of intersecting vehicle B
SVC=stop location of intersecting vehicle C
S100=stop location of main vehicle 100
ETAM=an estimated time of arrival (ETA) of the main vehicle 100 at its respective stop location. Operation of the main vehicle 100 is controlled by the intersection management module/autonomous driving module 113/160 to achieve non-simultaneity of arrival at the intersection as described herein.
ETAA=an ETA of the first intersecting vehicle at its respective stop location
ETAB=an ETA of the second intersecting vehicle at its respective stop location. If there is no third intersecting vehicle, the values of ETAC and ETA3 may be set to zero.
ETAC=an ETA of the third intersecting vehicle at its respective stop location. If there is only one intersecting vehicle, the values of ETAB and ETA2 may be set to zero.
ETA1=the ETA of whatever intersecting vehicle is estimated to arrive at its respective stop location first (i.e., at an earliest time) among the intersecting vehicles. ETA1 may be any of the ETAA, ETAB, and ETAC depending on the distances of the respective vehicle from their stop locations, the respective speeds of the vehicles, associated vehicle motion control information relating to each of the vehicle, etc.
ETA2=the ETA of whatever intersecting vehicle is estimated to arrive at its respective stop location in second place among the intersecting vehicles
ETA3=the ETA of whatever vehicle is estimated to arrive at its respective stop location in third place among the intersecting vehicles
DELAYM=a specified time difference (e.g., expressed in seconds) between arrival of the main vehicle 100 at its stop location and arrival of any of the intersecting vehicles at their respective stop locations.
DM1=a distance from the main vehicle 100 to its stop location
DVA=a distance from intersecting vehicle VA to its stop location
DVB=a distance from intersecting vehicle VB to its stop location
DVC=a distance from intersecting vehicle VC to its stop location
OCCVA=number of occupants in intersecting vehicle VA
OCCVB=number of occupants in intersecting vehicle VB
OCCVC=number of occupants in intersecting vehicle VC
OCCETA1=number of occupants in intersecting vehicle associated with ETA1
OCCETA2=number of occupants in intersecting vehicle associated with ETA2
OCCETA3=number of occupants in intersecting vehicle associated with ETA3

The value of DELAYM may be specified so as to make clear to human drivers of any intersecting vehicles exactly when the main vehicle 100 arrives at the intersection 201 in relation to any intersecting vehicle. This may aid the human drivers in knowing when to proceed through the intersection 201 based on a common understanding that vehicles stopped at the intersection will proceed through the intersection 201 in the order in which they arrived and stopped at their respective stop locations near the intersection. For example, in some arrangements, DELAYM may be set equal to 2.5 seconds. In this case, operation of the main vehicle 100 may be controlled so that ETAM is 2.5 seconds (±a specified tolerance value) either ahead of or behind the ETA of any intersecting vehicle. Thus, it becomes readily perceptible to a human driver of an intersecting vehicle already stopped at the intersection 201 that the main vehicle 100 arrived after the intersecting vehicle when the main vehicle 100 arrives at the intersection 2.5 seconds after the intersecting vehicle. Similarly, it may be readily perceptible to a human driver of another intersecting vehicle arriving at the intersection after the main vehicle 100 that the main vehicle 100 arrived before the other intersecting vehicle when the main vehicle 100 arrives at the intersection 2.5 seconds before the other intersecting vehicle.

In one or more arrangements, an intersection management module 113 as described herein can be configured to determine the existence of conditions described herein and/or to determine or estimate (and/or to acquire data and other information usable for determining or estimating) values of one or more of the parameters relevant for controlling operation of the main vehicle 100 so that the main vehicle stops near the intersection non-simultaneously with all intersecting vehicles. The intersection management module 113 may also be configured to cooperate with elements of the sensor system 120 to determine the existence of conditions described herein and/or to determine or estimate values of one or more of the parameters relevant for controlling operation of the main vehicle 100 as described herein.

In one or more arrangements, the intersection management module 113 may include computer-readable instructions that when executed by the processor cause the processor to (i.e., intersection management module 113 may be configured to) communicate with vehicle systems 140 and with any other elements or systems of the main vehicle 100 as required to control operation of the main vehicle 100 so that the main vehicle stops near an intersection non-simultaneously with all intersecting vehicles. As used herein, “non-simultaneously” means that arrival of the main vehicle 100 at its stop location is spaced apart in time by at least DELAYM from all intersecting vehicles, so that the main vehicle 100 all intersecting vehicles arrive at the intersection at least DELAYM before or after the main vehicle 100.

The intersection management module 113 may be configured to determine when the main vehicle 100 is within a predetermined distance X1 of an intersection 201, is unobstructed, and is approaching the intersection. The intersection management module 113 may be configured to, responsive to detection of all of these conditions, attempt to detect at least one intersecting vehicle along one of roads leading into the intersection 201. The intersection management module 113 may also be configured to, responsive to the detection of the above conditions and at least one intersecting vehicle, activate the intersection management protocol.

In one or more arrangements, the intersection management protocol may include all of the computer-readable instructions needed to control operation of the main vehicle 100 so that the main vehicle stops near an intersection non-simultaneously with all intersecting vehicles. Computer-readable instructions for performance of the protocol may reside on the intersection management module 113 or portions of the protocol may re side at other locations (e.g., on data stores 115). Activation of the protocol may cause activation of an ETA timer, acquisition of any information necessary to determine vehicle stop locations and estimate vehicle ETAs, processing of information to estimate the vehicle ETAs, and any the performance of any other functions necessary for control of the main vehicle 100 to achieve non-simultaneous arrival of the main vehicle 100 at its stop location near the intersection 201. The ETA timer (previously initialized at “0”) may be used for estimating and tracking vehicle ETAs (i.e., the ETAs may be estimated with reference to the start of the timer at “0” (e.g., at 0 seconds).

The intersection management module 113 may be configured to, after activation of the intersection management protocol, estimate an ETA of each intersecting vehicle. To this end, the intersection management module 113 may be configured to determine a respective location (i.e., a “stop location”) near the intersection where each vehicle (i.e., the main vehicle 100 and each intersecting vehicle) may stop prior to crossing the intersection 201. Each vehicle approaching the intersection 201 may have an associated stop location near the intersection. In embodiments described herein, operation of the main vehicle 100 may be controlled by the intersection management module 113 to stop at its respective stop location. In one or more arrangements, the stop location for a given vehicle at the intersection 201 may be determined by the intersection management module 113 after the vehicle is determined to be within a predetermined distance (e.g., distance X1) of the intersection 201 and approaching the intersection.

In some examples, the stop location may be based on a stop line painted on a road near the intersection and along which the vehicle is moving, and which is detected by environment sensors 122 of the main vehicle 100. For example, the intersection management module 113 may be configured to control the main vehicle 100 to stop so that a forward-most portion of the main vehicle extends a predetermined horizontal distance from a virtual vertical plane extending through the road stop line.

In other examples, the stop location may be based on an edge or curb of an intersecting road positioned closest to the main vehicle (e.g., curb 298 with respect to main vehicle 100 in FIG. 2), and which may be detected by environment sensors 122 of the main vehicle 100. For example, the vehicle stop location may be at a predetermined horizontal distance from a virtual vertical plane extending through a virtual line extending from curbs or edges of roads (such as virtual line 299 extending from curb 298).

In some examples, a vehicle stop location may be based on a location of a post supporting a stop sign (such as a stop sign 297 in FIG. 2) positioned along a curb near the intersection, and which is detected by environment sensors 122 of the main vehicle 100. For example, the intersection management module 113 may be configured to control the main vehicle 100 to stop so that a forward-most portion of the vehicle extends a predetermined horizontal distance from a virtual vertical plane extending through the post supporting the stop sign 297.

In particular arrangements, for purposes of determining a stop location for a given intersecting vehicle, in some arrangements, the intersection management module 113 may be configured to access any available historical information regarding where the intersecting vehicle tends to stop in relation to an intersection. For example, driving records relating to the intersecting vehicle may indicate a tendency of the vehicle to be stopped past a painted street stop line or at another location not contemplated as a stop location for purposes of determining the stop location by the intersection management module 113. Use of such information (if available) may provide a more accurate estimate of the stop location of a particular intersecting vehicle. Such information may be accessed with reference to the intersecting vehicle license plate number as detected by environment sensors 122. The information may be available from cloud resources 210, having been uploaded previously from the intersecting vehicle. In another arrangement, the stop information may be stored in a memory in the given intersecting vehicle and may be accessed by communication with the intersecting vehicle via main vehicle communications interface 169. Vehicle 100 may communicate with cloud resources 210 and/or intersecting vehicles along a suitable known wireless communications network via the vehicle wireless communications interface 169 incorporated into the main vehicle 100.

Other methods and/or criteria may be used to determine a stop location for a vehicle adjacent the intersection 201. Also, the intersection management module 113 may be configured to use any of several methods of determining a stop location for a vehicle. A best method of determining the stop location may be employed depending on a particular situation, including considerations such as weather conditions, road conditions, visibility of the intersection from the vehicle, availability of navigational information from sources (such as cloud resources 210) exterior of the vehicle, and other pertinent factors. The stop location of a vehicle may be determined using any suitable information, including sensor data, vehicle motion control information 117, information received from navigation system 147 or from cloud resources 210 and/or from any other suitable, available information.

Also further to estimating an ETA of an intersecting vehicle, the main vehicle sensor system 120 may acquire the current speed of the intersecting vehicle and the current distance of the intersecting vehicle from its associated stop location. The intersection management module 113 may be configured to, using the stop location, intersecting vehicle speed, and intersecting vehicle distance from the stop location, refer to the vehicle motion control information 117 stored in data stores 115. The intersection management module 113 may be configured to apply this vehicle motion control information to each intersecting vehicle (e.g., by curve matching, curve fitting, etc.) to estimate a safe and comfortable deceleration rate required for the intersecting vehicle to reach its respective stop location. The intersection management module 113 may be configured to, using the intersecting vehicle speed, distance and deceleration information, and the vehicle motion control information 117, estimate an ETA for the intersecting vehicle.

The intersection management module 113 may be configured to, after estimating an ETA for each intersecting vehicle, arrange the ETAs of all intersecting vehicle(s) in projected order of arrival at their respective stop locations (i.e., in order from earliest ETA to latest ETA). Referring to FIG. 2, for example, this enables determination of the order in which the intersecting vehicles VA, VB and VC should arrive at their respective stop locations. For example, the intersecting vehicle projected to arrive earliest at its associated stop location (according to its ETA) may be associated with the parameter ETA1 (e.g., if vehicle VA is projected to arrive at its stop location first, then ETA1 may be set to equal ETAA). Similarly, the intersecting vehicle projected to arrive next (i.e., in second place) at its associated stop location according to its ETA may be associated with the parameter ETA2. Also, the intersecting vehicle projected to arrive next (i.e., in third place) at its associated stop location according to its ETA may be associated with the parameter ETA3. A tolerance value (e.g., 0.1 second) may be attached to the ETAs estimated by the intersection management module 113.

In one or more arrangements, the intersection management module 113 may be configured to, after estimating the intersecting vehicle ETAs, determine if it is feasible to control operation of the main vehicle 100 so that ETA1−ETAM=DELAYM (i.e., so that the main vehicle can be controlled so as to arrive at its stop location an amount of time DELAYM before arrival of the intersecting vehicle associated with ETA1 at its stop location).

As mentioned previously, the vehicle motion control information 117 used in controlling the main vehicle 100 is determined and compiled with regard to considerations of safety and comfort of vehicle occupants. Thus, it is desirable to determine main vehicle control schemes and evaluate proposed main vehicle control schemes with reference to the vehicle motion control information 117, so that safety and comfort limits are not exceeded by the proposed control scheme. Terms such as “feasibility of control” or “feasible to control” as used herein denote a determination as to whether or not it is practical (based on the safety and comfort considerations embodied in the vehicle motion control information 117) to control the main vehicle 100 so as to achieve a certain ETAM. Control of the main vehicle to achieve certain ETAMs may require that the speed, acceleration and/or deceleration of the main vehicle exceed the safety and comfort-based control parameters embodied in the vehicle motion control information 117. If a control scheme (e.g., a combination of acceleration, constant speed and deceleration) necessary to achieve a proposed ETAM would lie within the control parameters embodied in vehicle motion control information 117, it may be considered “feasible” to control the main vehicle 100 so as to achieve the proposed ETAM. In contrast, if the control scheme necessary to achieve a proposed ETAM would require that the control parameters embodied in vehicle motion control information 117 be exceeded, it may be considered “infeasible” to control the main vehicle 100 so as to achieve the proposed ETAM.

Factors affecting feasibility of control parameter values for the main vehicle 100 may include the estimated current distance DM1 to the main vehicle stop location S100, legal minimum and/or maximum allowable speed limit on the road, the estimated required stopping distance for the main vehicle 100 at given speed and deceleration rate (which may be affected by road conditions, mechanical condition of tires, mechanical condition of braking system, other vehicle response characteristics (e.g., acceleration the vehicle can develop in response to operation of throttle controls, the dynamic response of the braking system during actuation, etc.) and other pertinent factors.

The intersection management module 113 may be configured to, if it is feasible to control operation of the main vehicle so that ETA1−ETAM=DELAYM, control operation of the main vehicle so that ETA1−ETAM=DELAYM. In this case, the main vehicle 100 would arrive at the intersection before the earliest intersecting vehicle (and also before any other intersecting vehicle).

The intersection management module 113 may be configured to, if it is not feasible to control operation of the main vehicle so that ETA1−ETAM=DELAYM, control operation of the main vehicle so that ETAM−ETA1>=DELAYM (i.e., so that the intersecting vehicle associated with ETA1 arrives at its associated stop location at least DELAYM seconds before the main vehicle 100 arrives at its stop location). In this case, since it is infeasible to control the main vehicle 100 so that it arrives DELAYM ahead of the earliest vehicle, it is proposed to control the main vehicle 100 so that is arrives at its stop location at least DELAYM after the intersecting vehicle associated with ETA1 arrives at its associated stop location. This ensures a perceptible time gap between stops of the earliest intersecting vehicle and the main vehicle 100.

In one or more arrangements, the intersection management module 113 may be configured to, as part of a proposed control scheme for the main vehicle 100, set ETAM=ETA1+DELAYM (i.e., so that the main vehicle 100 arrives at its stop location DELAYM seconds after the intersecting vehicle associated with ETA1 arrives at its stop location). The intersection management module 113 may be configured to then determine if it is feasible to control operation of the main vehicle so that ETAM=ETA1+DELAYM (i.e., according to the proposed control scheme). The intersection management module 113 may be configured to, if it is feasible to control operation of the main vehicle so that ETAM=ETA1+DELAYM, determine if ETA2=0. If ETA2=0, then there is no second intersecting vehicle and the main vehicle 100 need only adapt to the movements of the intersecting vehicle associated with ETA1. Thus, the intersection management module 113 may be configured to, if ETA2=0, control operation of the main vehicle so that ETAM=ETA1+DELAYM.

However, if ETA2 is non-zero, then a second intersecting vehicle has been detected. the intersection management module 113 may then determine if |ETA2−ETAM|>=DELAYM (i.e., if an absolute value of ETA2−ETAM is greater than or equal to the desired delay period DELAYM between arrivals at the intersection). If this condition is determined to be true, then ETAM can be specified according to the proposed control scheme (ETAM=ETA1+DELAYM) because this will provide the desired arrival time gap between ETAM and ETA2. Thus, the intersection management module 113 may control operation of the main vehicle 100 so that ETAM=ETA1+DELAYM.

However, if the condition if |ETA2−ETAM|>=DELAYM is determined not to be true, or it is infeasible to control operation of the main vehicle so that ETAM=ETA1+DELAYM, the intersection management module 113 may control operation of the main vehicle so that ETAM>=ETA2+DELAYM (i.e., so that the main vehicle will arrive at its stop location at some point in time at or later than ETA2+DELAYM). This ensures the desired time gap of DELAYM between arrival of main vehicle 100 and arrival of the intersecting vehicle associated with ETA1, and between arrival of main vehicle 100 and arrival of the intersecting vehicle associated with ETA2. Also, as the value of ETAM increases, the main vehicle arrives at its stop location at a relatively later time, which may enhance feasibility of the proposed control scheme because the main vehicle is proceeding at a relatively slower speed toward the intersection, which may increase the safety and comfort of the ride.

In one or more arrangements, the intersection management module 113 may be configured to, as part of a proposed control scheme for the main vehicle 100, set ETAM=ETA2+DELAYM (i.e., so that the main vehicle 100 arrives at its stop location DELAYM seconds after the intersecting vehicle associated with ETA2 arrives at its stop location). The intersection management module 113 may be configured to then determine if it is feasible to control operation of the main vehicle so that ETAM=ETA2+DELAYM (i.e., according to the proposed control scheme). The intersection management module 113 may be configured to, if it is feasible to control operation of the main vehicle so that ETAM=ETA2+DELAYM, determine if ETA3=0. If ETA3=0, then there is no third intersecting vehicle and the main vehicle 100 need only adapt to the movements of the intersecting vehicles associated with ETA1 and ETA2. Since ETA2 occurs later than ETA1, if the arrival time of the main vehicle is spaced after ETA2, it will also be spaced after ETA1. Thus, the intersection management module 113 may, if ETA3=0, control operation of the main vehicle so that ETAM=ETA2+DELAYM.

However, if ETA3 is non-zero, then a third intersecting vehicle has been detected. the intersection management module 113 may then determine if |ETA3−ETAM|>=DELAYM (i.e., if an absolute value of ETA3−ETAM is greater than or equal to the desired delay period DELAYM between arrivals at the intersection). If this condition is determined to be true, then ETAM can be specified according to the proposed control scheme (ETAM=ETA2+DELAYM) because this will provide the desired arrival time gap between ETAM and ETA3. Thus, the intersection management module 113 may control operation of the main vehicle 100 so that ETAM=ETA2+DELAYM.

However, if the condition if |ETA3−ETAM|>=DELAYM is determined not to be true, or it is infeasible to control operation of the main vehicle so that ETAM=ETA2+DELAYM, the intersection management module 113 may control operation of the main vehicle so that ETAM>=ETA3+DELAYM (i.e., so that the main vehicle will arrive at its stop location at some point in time at or later than ETA3+DELAYM). This ensures the desired time gap of DELAYM between arrival of main vehicle 100 and arrival of the intersecting vehicle associated with ETA2, and between arrival of main vehicle 100 and arrival of the intersecting vehicle associated with ETA3.

In one or more arrangements, the intersection management module 113 may be configured to, as part of a proposed control scheme for the main vehicle 100, set ETAM=ETA3+DELAYM (i.e., so that the main vehicle 100 arrives at its stop location DELAYM seconds after the intersecting vehicle associated with ETA3 arrives at its stop location). The intersection management module 113 may be configured to then determine if it is feasible to control operation of the main vehicle so that ETAM=ETA3+DELAYM (i.e., according to the proposed control scheme). The intersection management module 113 may be configured to, if it is feasible to control operation of the main vehicle so that ETAM=ETA3+DELAYM, control operation of the main vehicle so that ETAM=ETA3+DELAYM. The intersection management module 113 may be configured to, if it is infeasible to control operation of the main vehicle so that ETAM=ETA3+DELAYM, control operation of the main vehicle so that ETAM >ETA3+DELAYM. This ensures the desired time gap of DELAYM between arrival of main vehicle 100 and arrival of the intersecting vehicle associated with ETA3.

In some arrangements, the processor(s) 110 and the intersection management module 113 can be operably connected to communicate with the other elements of the vehicle, including various vehicle systems 140 and/or individual components thereof, to operationally control operational control of the main vehicle 100 to achieve a desired estimated arrival time (ETA) for the main vehicle 100. The intersection management module 113 and the processor(s) 110 can be operably connected with each other and operably communicate with the processor(s) 110 to perform and/or manage performance of the functions described herein as necessary for controlling operation of the main vehicle 100 to arrive at an intersection non-simultaneously with detected intersecting vehicles. This may include functions such as acquisition of information, processing of information, estimation of ETAs, necessary adjustment of main vehicle ETA, control of the main vehicle to achieve a desired main vehicle ETA, etc.).

In some arrangements, the processor(s) 110, the autonomous driving module(s) 160 and the intersection management module 113 can be operably connected to communicate with the other elements of the main vehicle 100, including various vehicle systems 140 and/or individual components thereof to perform and/or manage performance of the functions described herein as necessary for controlling operation of the main vehicle to arrive at an intersection non-simultaneously with detected intersecting vehicles. Thus, in some arrangements, the main vehicle 100 may be controlled to perform intersection management-related functions in by the intersection management module 113 in cooperation with the autonomous driving module(s) 160.

For example, returning to FIG. 1, the processor(s) 110 and/or the autonomous driving module(s) 160, in cooperation with the intersection management module 113, can be in communication to send and/or receive information from the various vehicle systems 140 to control the movement, speed, maneuvering, heading, direction, etc. of the main vehicle 100. The processor(s) 110 and/or the autonomous driving module(s) 160 may, in cooperation with the intersection management module, control some or all of these vehicle systems 140 and, thus, may be partially or fully autonomous.

The processor(s) 110 and/or the autonomous driving module(s) 160, in cooperation with the intersection management module 113, may be operable to control the navigation and/or maneuvering of the main vehicle 100 by controlling one or more of the vehicle systems 140 and/or components thereof. For instance, when operating in an autonomous mode, the processor(s) 110 and/or the autonomous driving module(s) 160, in cooperation with the intersection management module 113, can control the direction and/or speed of the main vehicle 100. The processor(s) and/or the autonomous driving module(s) 160 can cause the main vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels).

In one or more arrangements, the intersection management module 113 may be configured to receive a notice of emergency condition occurring with regard to an intersecting vehicle. A “notice of emergency condition” regarding an intersecting vehicle is an indication that the vehicle and/or its occupants are experiencing some type of emergency (e.g., a medical emergency) that necessitates the vehicle reaching its destination as quickly as possible.

To facilitate rapid passage of such a vehicle, the intersection management module 113 may be configured to respond to a received notice of emergency condition by controlling operation of the main vehicle 100 so that the main vehicle reaches its stop location after the intersecting vehicle reaches its stop location. This may ensure that the intersecting vehicle does not have to wait for the main vehicle to proceed through the intersection. this “emergency condition” control function may be selectable by a user of the main vehicle as a control option (i.e., the user may elect, via the vehicle input system 130 that the main vehicle be controlled as described herein to facilitate rapid passage of an intersecting vehicle experiencing an emergency condition).

In particular arrangements, the notice of an emergency condition may be received via the communications interface 169 from any V2X entity that may have (or have access to) such information. In some arrangements, the intersection management module 113 may be configured to automatically generate a query to one or more V2X entities regarding whether an intersecting vehicle is experiencing an emergency condition (i.e., an “emergency condition” query) as soon as the vehicle is detected. For purposes of the query, the intersecting vehicle may be identified by its license plate number or by any other suitable method. In some arrangements, the intersection management module 113 may be configured to automatically generate a V2V “emergency condition” query to each intersecting vehicle regarding the emergency status of the vehicle.

In one or more arrangements, the environment sensors 122 may be configured to detect or estimate a total number of occupants in each detected intersecting vehicle (e.g., using cameras, etc.). In some arrangements, the intersection management module 113 may be configured to control operation of the main vehicle 100 so that the main vehicle reaches its stop location after an intersecting vehicle reaches its stop location when the intersecting vehicle contains at least (or more than) a specific number of occupants. This function permits an intersecting vehicle containing multiple occupants to proceed through the intersection ahead of the main vehicle as a courtesy. This “occupant priority mode” control function may be selectable by a user of the main vehicle as a control option (i.e., the user may elect, via the vehicle input system 130 that the main vehicle 100 be controlled as described herein to facilitate rapid passage of an intersecting vehicle having at least the specific number of occupants).

FIGS. 4-8 are flow and schematic diagrams describing operation of an embodiment of the vehicle control system incorporated into the main vehicle 100. FIG. 4 is a flow diagram illustrating a sequence of events causing activation of an intersection management protocol to be implemented by an intersection management module in accordance with embodiments described herein. The main vehicle 100 may be controlled so that it reaches its stop location as soon as possible while maintaining a time spacing of at least DELAYM between arrival of the main vehicle 100 and the arrival of any intersecting vehicle, either before or after arrival of the main vehicle.

In the following description and examples, it is assumed that three intersecting vehicles VA, VB and VC are approaching the intersection 201 at the same time as main vehicle 100, as shown in FIG. 2. However, the intersection management module 113 may operate in same manner to control the main vehicle 100 if only one or two intersecting vehicles are approaching the intersection 201. For example, in the case of only one intersecting vehicle, an ETA of the intersecting vehicle would be estimated and ETAM for the main vehicle 100 would be determined in relation to the single intersecting vehicle.

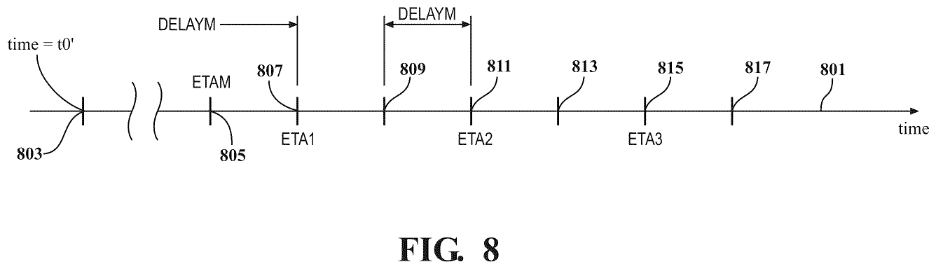

FIG. 8 is a schematic representation of a timeline illustrating possible relative estimated arrival times of a main vehicle with respect to an estimated arrival time of each vehicle of multiple intersecting vehicles, when the estimated arrival time of the main vehicle is controlled responsive to the estimated arrival times of the intersecting vehicles. Referring to FIGS. 2 and 8, in scenarios described herein, the main vehicle 100 may be moving along a road 211 toward an intersection 201 when it is determined that one or more intersecting vehicles are also moving toward the intersection from different directions. Thus, for example, the main vehicle 100 may be moving along the road at speed limit SL1 when (at time=t0′) one or more intersecting vehicles are detected. The ETA timer may then activate at time=t0′.

FIG. 4 is a flow diagram illustrating a sequence of events causing activation of an intersection management protocol to be implemented by an intersection management module 113 in accordance with embodiments described herein. Referring to FIG. 4, the intersection management module 113 may be configured to (in block 402) determine when the main vehicle 100 is within a predetermined distance X1 of an intersection, is unobstructed, and is approaching the intersection. The intersection management module 113 may be configured to (in block 404), responsive to detection of the conditions in block 402, attempt to detect at least one intersecting vehicle along one of roads leading into the intersection 201. The intersection management module 113 may also be configured to, responsive to the detection of at least one intersecting vehicle in block 404, activate the intersection management protocol (block 406).

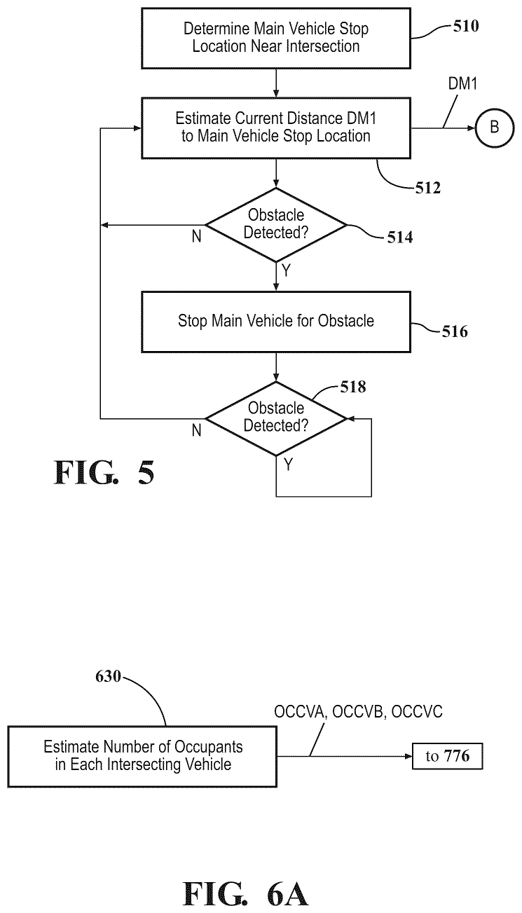

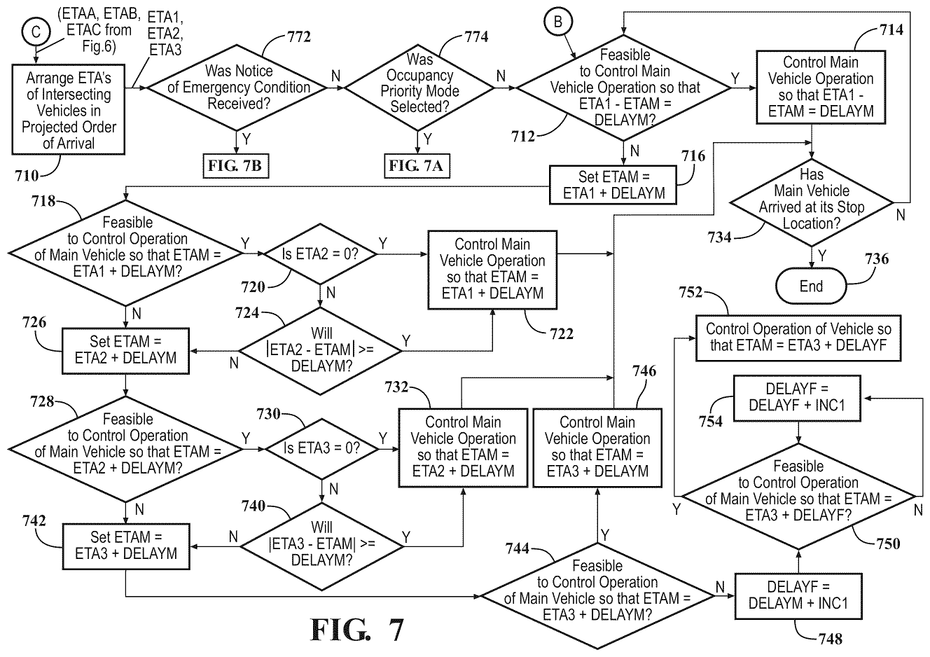

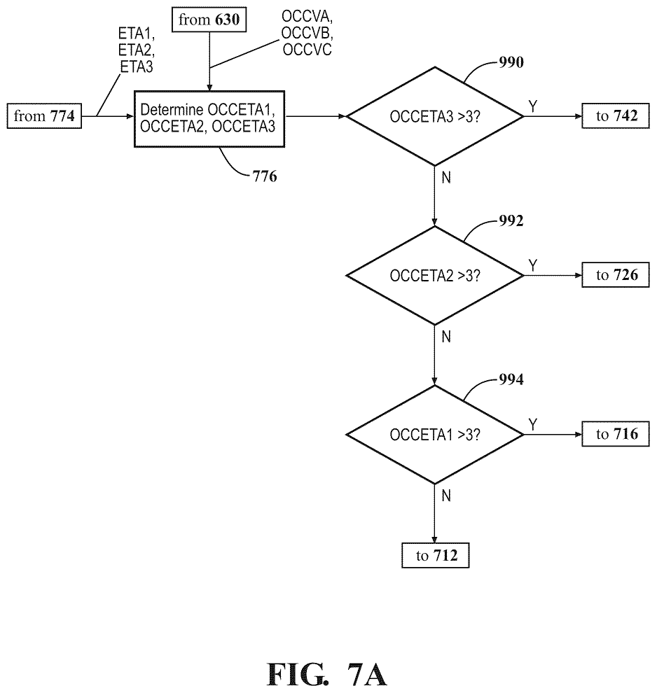

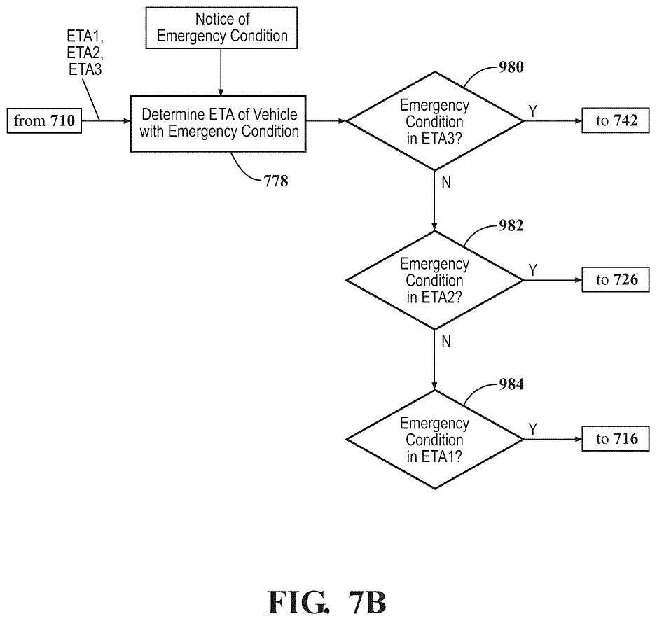

FIG. 5 is a is a flow diagram illustrating one example of a process for estimating and/or determining values of parameters used for controlling an estimated time of arrival (ETA) of a main vehicle at an intersection in relation to ETAs of intersecting vehicles also approaching the intersection. Referring to FIG. 2 and. 5, the intersection management module 113 may be configured to (in block 510) determine a stop location for the main vehicle 100. The intersection management module 113 may be configured to (in block 512) determine a current distance DM1 of the main vehicle 100 from its associated stop location S100. This distance DM1 may be updated with each sensor acquisition cycle in blocks 512-518 and transmitted to block 712 (FIG. 7) unless an obstacle (e.g., a pedestrian, a cyclist, etc.) is suddenly positioned between the main vehicle 100 and its stop location S100.

The intersection management module 113 may be configured to, if an obstacle is detected in block 514, control operation of the main vehicle 100 to stop the main vehicle for the obstacle (block 516). The intersection management module may be configured to (in block 518) maintain the main vehicle 100 in the stopped condition until the obstacle is no longer blocking the main vehicle 100. When the obstacle is no longer present, the intersection management module may use the current distance DM1 to estimate ETAM as shown in FIG. 7.

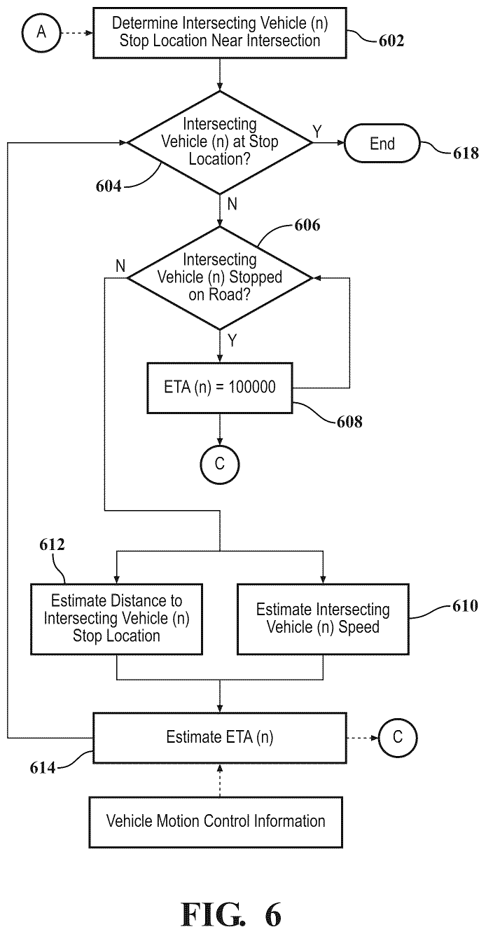

FIG. 6 is a flow diagram illustrating a process for determining an ETA for each intersecting vehicle detected by sensors of the main vehicle, and for updating the ETA of each intersecting vehicle. The steps in the flow diagram shown in FIG. 6 may be performed for each individual intersecting vehicle VA, VB and VC to estimate an associated ETA for the respective vehicle. Referring to FIG. 6, the intersection management module 113 may be configured to (in block 602) determine an associated stop location for the intersecting vehicle, in a manner previously described. The intersection management module 113 may be configured to (in block 604) determine if the intersecting vehicle has arrived at its respective stop location. If the intersecting vehicle has arrived at its respective stop location, execution of the routine shown FIG. 6 may end.

However, if the intersecting vehicle has not yet arrived at its respective stop location, the intersection management module 113 may (in block 606) determine if the intersecting vehicle has stopped along the road on which it is traveling (e.g., due to the sudden presence of an obstacle). If the intersecting vehicle has stopped along the road, the intersection management module 113 may (in block 608) set the ETA of the intersecting vehicle to a default value high enough to remove the intersecting vehicle from the group of intersecting vehicles being evaluated to estimate the main vehicle ETA (ETAM). This is because (assuming that this intersecting vehicle is the only intersecting vehicle stopped) the other vehicles will continue to move toward the intersection, while it is assumed to be undetermined when the stopped intersecting vehicle will resume movement toward the intersection 201. Thus, for example, an intersecting vehicle may initially be associated with ETA1 (i.e., this vehicle may be projected to be the first intersecting vehicle to reach its associated stop location). If an obstacle is suddenly placed in the path of this intersecting vehicle and the vehicle stops, the vehicle may be delayed such that it is no longer projected to be the first intersecting vehicle to arrive at the intersection.

Returning to block 606, if the intersecting vehicle is not stopped, the intersection management module 113 may (in block 610) estimate (or acquire an estimate) of the current distance of the intersecting vehicle from its respective stop location. Simultaneously, the intersection management module 113 may also (in block 612) estimate (or acquire an estimate) of the current speed of the intersecting vehicle toward the intersection. The intersection management module 113 may then (in block 614), using the speed, distance, vehicle motion control information 117 and any other pertinent information, estimate an ETA for the intersecting vehicle.

In the example shown in FIG. 2, after determination of the stop location of the intersecting vehicle in block 602, the loop defined by blocks 604-614 may be executed continuously or repeatedly for each intersecting vehicle, to update ETAA, ETAB, and/or ETAC of the intersecting vehicles. Each updated ETA is forwarded to block 710 of FIG. 7 as soon as it is determined. It has been found that, in most cases, vehicles traveling along a road toward an intersection will travel at a relatively constant speed toward the intersection after they have reached a certain proximity to the intersection (e.g., ¾ to ½ a block from the intersection). Thus, estimated ETAs of the intersecting vehicles (and the projected order of their arrival at their respective stop locations) may not vary greatly after the intersecting vehicles have reached a certain proximity to the intersection. Also, proximity to the intersection may facilitate detection of the intersecting vehicles by the main vehicle sensor system 120. Thus, in some arrangements, the detection distance X1 from the intersection may be set to a value within the range ¾ to ½ a block from the intersection.

Referring to FIG. 6A, the environment sensors 122 may be configured to (in block 630), simultaneously with the operations in block 602, estimate the number of occupants in each intersecting vehicle. For example, the number of occupants estimated to be in intersecting vehicle VA may be assigned to the identifier OCCVA. Similarly, the numbers of occupants estimated to be in intersecting vehicles VB and VC may be assigned to the identifiers OCCVB and OCCVC, respectively. This information can be conveyed to new block 776 in FIG. 7A.

FIG. 7 is a flow diagram illustrating a process for controlling an estimated time of arrival (ETA) of a main vehicle at its stop location in relation to ETAs of intersecting vehicles also approaching their respective stop locations, in accordance with embodiments described herein. FIG. 8 is a schematic representation of a timeline 801 illustrating possible relative estimated arrival times of a main vehicle with respect to an estimated arrival time of each intersecting vehicle of multiple intersecting vehicles, when the estimated arrival time of the main vehicle is controlled responsive to the estimated arrival times of the intersecting vehicles.

Referring to FIG. 8, activation of the intersection management protocol may occur at time=t0′ (at position 803 on the timeline 801) when the intersection management module 113 determines (e.g., based on data from main vehicle sensor system 120) that the main vehicle 100 is within a predetermined distance of an intersection 201, is unobstructed, is approaching the intersection, and that at least one intersecting vehicle is detected.

Referring to FIG. 7, the intersection management module 113 may be configured to (in block 710) arrange the intersecting vehicle ETAs (in this case, ETAA, ETAB and ETAC) in projected order of arrival at their respective stop locations. This may result in, for example, the ETA associated with the first intersecting vehicle projected to arrive at its respective stop location being assigned to ETA1. Similarly, the ETA associated with the second intersecting vehicle projected to arrive at its respective stop location may be assigned to ETA2, and the ETA associated with the third intersecting vehicle projected to arrive at its respective stop location may be assigned to ETA3. This information may be forwarded for use in the subsequent steps of the control loop.

The intersection management module 113 may be configured to (in block 772) determine if a notice of emergency condition was received in the main vehicle 100. The intersection management module 113 may be configured to, if the “emergency condition” control function was enabled and a notice of emergency condition was received, determine an ETA of the vehicle experiencing the emergency condition by associating each vehicle with its ETA (block 778 of FIG. 7B).. The intersection management module 113 may be configured to determine (in block 980) if the emergency condition is occurring in the intersecting vehicle associated with ETA3. If the emergency condition is occurring in the intersecting vehicle associated with ETA3, control may pass to block 742 to ensure that ETAM is initialized and to control the main vehicle 100 to arrive behind the vehicle associated with ETA3.

However, if the emergency condition is not occurring in the intersecting vehicle associated with ETA3, the intersection management module 113 may determine (in block 982) if the emergency condition is occurring in the intersecting vehicle associated with ETA2. If the emergency condition is occurring in the intersecting vehicle associated with ETA2, control may pass to block 726 to ensure that ETAM is initialized and to control the main vehicle 100 to arrive behind the vehicle associated with ETA2. However, if the emergency condition is not occurring in the intersecting vehicle associated with ETA2, the intersection management module 113 may confirm (in block 984) that the emergency condition is occurring in the intersecting vehicle associated with ETA1. When it is confirmed that the emergency condition is occurring in the intersecting vehicle associated with ETA1, control may pass to block 716 to ensure that ETAM is initialized and to control the main vehicle 100 to arrive behind the vehicle associated with ETA1.

Returning to block 772, if the “emergency condition” control function was not enabled and/or a notice of emergency condition was not received, the intersection management module 113 may determine (in block 774) if the “occupancy priority” mode was selected by a user. The intersection management module 113 may, if the “occupancy priority” mode was selected by a user, associate ETA information with occupancy information of each vehicle in block 776 of FIG. 7A. This block associates the number of occupants in each vehicle with the estimated arrival order of the respective intersecting vehicle to assign values to OCCETA1, OCCETA2 and OCCETA3.

The number of occupants to be used as a priority threshold may be selectable by a user. Assuming for purposes of discussion that an intersecting vehicle having more than 3 occupants is to be given priority, the intersection management module 113 may (in block 990) determine if OCCETA3>3 (i.e., if the number of occupants in the vehicle associated with ETA3 exceeds the threshold). If the number of occupants in the vehicle associated with ETA3 exceeds the threshold, control may pass to block 742 to ensure that ETAM is initialized and to control the main vehicle 100 to arrive behind the vehicle associated with ETA3.

However, if the number of occupants in the vehicle associated with ETA3 does not exceed the threshold, the intersection management module 113 may (in block 992) determine if OCCETA2>3 (i.e., if the number of occupants in the vehicle associated with ETA2 exceeds the threshold). If the number of occupants in the vehicle associated with ETA2 exceeds the threshold, control may pass to block 726 to ensure that ETAM is initialized and to control the main vehicle 100 to arrive behind the vehicle associated with ETA2.

However, if the number of occupants in the vehicle associated with ETA2 does not exceed the threshold, the intersection management module 113 may (in block 994) determine if OCCETA1>3 (i.e., if the number of occupants in the vehicle associated with ETA1 exceeds the threshold). If the number of occupants in the vehicle associated with ETA1 exceeds the threshold, control may pass to block 716 to ensure that ETAM is initialized and to control the main vehicle 100 to arrive behind the vehicle associated with ETA1. However, if the number of occupants in the vehicle associated with ETA1 does not exceed the threshold, it is determined that none of the intersecting vehicles contain a number of occupants exceeding the threshold. Control may then pass to block 712.

The intersection management module 113 may be configured to (in block 712) determine if it is feasible to control operation of the main vehicle 100 so that ETA1−ETAM=DELAYM. The intersection management module 113 may be configured to (in block 714), if it is feasible to control operation of the main vehicle 100 so that ETA1−ETAM=DELAYM, control operation of the main vehicle 100 so that ETA1−ETAM=DELAYM. In this case, ETAM may fall, for example, at position 805 along the timeline shown in FIG. 8. This may be spaced a time gap DELAYM seconds from position 807 where ETA1 falls. Thus, the main vehicle 100 may arrive at its stop location DELAYM seconds before the vehicle associated with ETA1 arrives at its respective stop location.

However, if it is infeasible to control operation of the main vehicle 100 so that ETA1−ETAM=DELAYM, the intersection management module 113 may (in block 716) set ETAM=ETA1+DELAYM (i.e., to a time DELAYM after ETA1) to be tested as an alternative proposed control scheme. The intersection management module 113 may then (in block 718) determine if it is feasible to control operation of the main vehicle so that ETAM=ETA1+DELAYM. If it is determined to be feasible to control operation of the main vehicle so that ETAM=ETA1+DELAYM, the intersection management module may (in block 720) determine if ETA2=0. If ETA2=0 (i.e., if there is no other intersecting vehicle detected), the intersection management module may (in block 722) control operation of the main vehicle so that ETAM=ETA1+DELAYM. In this case, for example, ETAM may be at position 809 along the timeline, DELAYM seconds after ETA1.

However, if ETA2 is non-zero, there is a second intersecting vehicle present (and estimated to arrive at its stop location at position 811 on the timeline). Then, the intersection management module 113 may (in block 724) determine if |ETA2−ETAM|>=DELAYM. If |ETA2−ETAM|>=DELAYM when ETAM is at position 809, controlling operation of the main vehicle 100 so that ETAM=ETA1+DELAYM will provide the desired time gap of at least DELAYM between the arrival of the main vehicle 100 and the arrival of the vehicle associated with ETA2. Thus, the intersection management module may (in block 722) control operation of the main vehicle 100 so that ETAM=ETA1+DELAYM.

However, if |ETA2−ETAM| is not >=DELAYM or it is infeasible (in block 718) to control operation of the main vehicle 100 so that ETAM=ETA1+DELAYM, the intersection management module 113 may (in block 726) set ETAM=ETA2+DELAYM to be tested as an alternative proposed control scheme to ensure that the main vehicle 100 arrives at its respective stop location spaced apart at least DELAYM from both ETA1 and ETA2.

Proceeding from block 726, the intersection management module 113 may be configured to (in block 728) determine if it is feasible to control operation of the main vehicle so that ETAM=ETA2+DELAYM. If it is feasible to control operation of the main vehicle 100 so that ETAM=ETA2+DELAYM, the intersection management module 113 may (in block 730) determine if ETA3=0. If ETA3=0, the intersection management module 113 may (in block 732) control operation of the main vehicle so that ETAM=ETA2+DELAYM. In this case, ETAM may fall at a position 813 which may be DELAYM seconds behind ETA2.

However, if ETA3 is non-zero, the intersection management module 113 may (in block 740) determine if |ETA3−ETAM|>=DELAYM. If |ETA3−ETAM|>=DELAYM, the intersection management module may (in block 732) control operation of the main vehicle so that ETAM=ETA2+DELAYM. If |ETA3−ETAM| is not >=DELAYM or it is infeasible (in block 728) to control operation of the main vehicle 100 so that ETAM=ETA2+DELAYM, the intersection management module may (in block 742) set ETAM=ETA3+DELAYM as an alternative proposed control scheme.

Proceeding from block 742, the intersection management module 113 may be configured to (in block 744) determine if it is feasible to control operation of the main vehicle 100 so that ETAM=ETA3+DELAYM. If it is feasible to control operation of the main vehicle 100 so that ETAM=ETA3+DELAYM, the intersection management module 113 may (in block 746) control operation of the main vehicle 100 so that ETAM=ETA3+DELAYM. In this case, ETAM may fall at a position 817 which may be DELAYM seconds behind ETA3 in position 815.

However, if it is infeasible to control operation of the main vehicle 100 so that ETAM=ETA3+DELAYM, the intersection management module 113 may (in block 748) set another delay parameter DELAYF=DELAYM+INC1. This is intended to increment the time delay between arrival of the third (i.e., last) intersecting vehicle at its stop location and the arrival of the main vehicle 100 at its stop location after arrival of the third vehicle.

If it is infeasible to control operation of the main vehicle 100 so that ETAM=ETA3+DELAYM, the parameter DELAYM may be repeatedly incremented as DELAYF (in block 754) and tested (in block 750) until a DELAYF is found that provides a feasible control scheme for the main vehicle 100. When a suitable DELAYF is found, the intersection management module 113 may (in block 752) control operation of the main vehicle 100 so that ETAM=ETA3+DELAYF, in order to implement the revised delay.

Referring back to blocks 722, 732 and 746, the intersection management module 113 may (in block 734), after controlling operation of the main vehicle 100 according to the control schemes recited in these steps, determine if the main vehicle has arrived at its stop location. If the main vehicle 100 has not yet arrived at its stop location, control may loop back to block 712 to repeatedly adjust ETAM according to changes (if any) in the ETAs of the intersecting vehicles.

It may be understood by one skilled in the pertinent art that the method illustrated in FIG. 7 determining an ETAM value suitably spaced apart from the ETAs of all of the intersecting vehicles may be adapted for any number of intersecting vehicles.

In other aspects, a vehicle control system in accordance with an embodiment described herein may incorporate a non-transitory computer-readable medium for controlling operation of a main vehicle and storing instructions that when executed by a processor cause the processor to control operation of the main vehicle while approaching an intersection so that the main vehicle stops near the intersection non-simultaneously with all intersecting vehicles.

The computer-readable may further store instructions that when executed by the processor cause the processor to estimate an estimated time of arrival (ETA) of each detected intersecting vehicle, and arrange ETAs of all detected intersecting vehicle(s) in projected order of arrival.

The computer-readable medium may further store instructions that when executed by the processor cause the processor to determine if it is feasible to control operation of the main vehicle so that ETA1−ETAM=DELAYM and, if it is feasible to control operation of the main vehicle so that ETA1−ETAM=DELAYM, control operation of the main vehicle so that ETA1−ETAM=DELAYM. The computer-readable medium may further storing instructions that when executed by the processor cause the processor to, if it is not feasible to control operation of the main vehicle so that ETA1−ETAM=DELAYM, control operation of the main vehicle so that ETAM−ETA1>=DELAYM.

The computer-readable medium may further store instructions that when executed by the processor cause the processor to:
set ETAM=ETA1+DELAYM;
determine if it is feasible to control operation of the main vehicle so that ETAM=ETA1+DELAYM;
if it is feasible to control operation of the main vehicle so that ETAM=ETA1+DELAYM, determine if ETA2=0;
if ETA2=0, control operation of the main vehicle so that ETAM=ETA1+DELAYM;
if ETA2 is non-zero, determine if |ETA2−ETAM|>=DELAYM;
if |ETA2−ETAM|>=DELAYM, control operation of the main vehicle so that ETAM=ETA1+DELAYM; and
if |ETA2−ETAM| is not >=DELAYM or it is infeasible to control operation of the main vehicle so that ETAM=ETA1+DELAYM, control operation of the main vehicle so that ETAM>=ETA2+DELAYM.

The computer-readable medium may further store instructions that when executed by the processor cause the processor to:
set ETAM=ETA2+DELAYM;
determine if it is feasible to control operation of the main vehicle so that ETAM=ETA2+DELAYM;
if it is feasible to control operation of the main vehicle so that ETAM=ETA2+DELAYM, determine if ETA3=0;
if ETA2=0, control operation of the main vehicle so that ETAM=ETA2+DELAYM;
if ETA2 is non-zero, determine if |ETA3−ETAM|>=DELAYM;
if |ETA3−ETAM|>=DELAYM, control operation of the main vehicle so that ETAM=ETA2+DELAYM; and
if |ETA3−ETAM| is not >=DELAYM or it is infeasible to control operation of the main vehicle so that ETAM=ETA2+DELAYM; control operation of the main vehicle so that ETAM>=ETA3+DELAYM.

The computer-readable medium may further store instructions that when executed by the processor cause the processor to:
set ETAM=ETA3+DELAYM;
determine if it is feasible to control operation of the main vehicle so that ETAM=ETA3+DELAYM;
if it is feasible to control operation of the main vehicle so that ETAM=ETA3+DELAYM;
control operation of the main vehicle so that ETAM=ETA3+DELAYM; and
if it is infeasible to control operation of the main vehicle so that ETAM=ETA3+DELAYM, control operation of the main vehicle so that ETAM>ETA3+DELAYM.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory (such as memory 111) generally stores the noted modules. The memory associated with a module may be a buffer or cache embedded within a processor, a RAM, a ROM, a flash memory, or another suitable electronic storage medium. In still further aspects, a module, as envisioned by the present disclosure, is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A vehicle control system comprising:
a processor; and
a memory communicably coupled to the processor and storing an intersection management module including computer-readable instructions that when executed by the processor cause the processor to control operation of a main vehicle so that the main vehicle stops near an intersection non-simultaneously with all intersecting vehicles.

2. The vehicle control system of claim 1, wherein the intersection management module includes computer-readable instructions that when executed by the processor cause the processor to:
(a) determine when the main vehicle is within a predetermined distance of an intersection, is unobstructed, and is approaching the intersection;
(b) detect at least one intersecting vehicle; and
(c) responsive to (a) and (b), activate an intersection management protocol.

3. The vehicle control system of claim 1, wherein the intersection management module includes computer-readable instructions that when executed by the processor cause the processor to:
estimate an ETA of each intersecting vehicle; and
arrange ETAs of all detected intersecting vehicle(s) in projected order of arrival.

4. The vehicle control system of claim 3, wherein the intersection management module includes computer-readable instructions that when executed by the processor cause the processor to, if it is determined to be feasible to control operation of the main vehicle so that ETA1−ETAM=DELAYM, then control operation of the main vehicle so that ETA1−ETAM=DELAYM.

5. The vehicle control system of claim 3, wherein the intersection management module includes computer-readable instructions that when executed by the processor cause the processor to, if ETA2 is non-zero and it is determined to be feasible to control operation of the main vehicle so that ETAM=ETA1+DELAYM and so that |ETA2−ETAM|=DELAYM, then control operation of the vehicle so that ETAM=ETA1+DELAYM.

6. The vehicle control system of claim 3, wherein the intersection management module includes computer-readable instructions that when executed by the processor cause the processor to, if ETA3 is non-zero and it is determined to be feasible to control operation of the main vehicle so that ETAM=ETA2+DELAYM and so that |ETA3−ETAM|=DELAYM, then control operation of the main vehicle so that ETAM=ETA2+DELAYM.

7. The vehicle control system of claim 3, wherein the intersection management module includes computer-readable instructions that when executed by the processor cause the processor to, if it is determined to be feasible to control operation of the main vehicle so that ETAM=ETA3+DELAYM, then control operation of the main vehicle so that ETAM=ETA3+DELAYM.

8. A method for controlling operation of a main vehicle, comprising a step of controlling operation of the main vehicle while approaching an intersection so that the main vehicle stops near the intersection non-simultaneously with all intersecting vehicles.

9. The method of claim 8, wherein the step of controlling operation of the main vehicle comprises a step of:
(a) determining when the main vehicle is within a predetermined distance of an intersection, is unobstructed, and is approaching the intersection;
(b) detecting at least one intersecting vehicle; and
(c) responsive to (a) and (b), activating an intersection management protocol.

10. The method of claim 8, wherein the step of controlling operation of the main vehicle comprises a step of:
estimating an ETA of each intersecting vehicle; and
arranging ETAs of all detected intersecting vehicle(s) in projected order of arrival.

11. The method of claim 10, wherein the step of controlling operation of the main vehicle comprises steps of:
determining if it is feasible to control operation of the main vehicle so that ETA1−ETAM=DELAYM;
if it is feasible to control operation of the main vehicle so that ETA1−ETAM=DELAYM, controlling operation of the main vehicle so that ETA1−ETAM=DELAYM; and
if it is not feasible to control operation of the main vehicle so that ETA1−ETAM=DELAYM, controlling operation of the main vehicle so that ETAM−ETA1>=DELAYM.

12. The method of claim 10, wherein the step of controlling operation of the main vehicle comprises steps of:
setting ETAM=ETA1+DELAYM;
determining if it is feasible to control operation of the main vehicle so that ETAM=ETA1+DELAYM;
if it is feasible to control operation of the main vehicle so that ETAM=ETA1+DELAYM, determining if ETA2=0;
if ETA2=0, controlling operation of the main vehicle so that ETAM=ETA1+DELAYM;
if ETA2 is non-zero, then determining if |ETA2−ETAM|>=DELAYM;
if |ETA2−ETAM|>=DELAYM, controlling operation of the main vehicle so that ETAM=ETA1+DELAYM; and
if |ETA2−ETAM| is not >=DELAYM or it is infeasible to control operation of the main vehicle so that ETAM=ETA1+DELAYM, controlling operation of the main vehicle so that ETAM>=ETA2+DELAYM.

13. The method of claim 10, wherein the step of controlling operation of the main vehicle comprises steps of:
setting ETAM=ETA2+DELAYM;
determining if it is feasible to control operation of the main vehicle so that ETAM=ETA2+DELAYM;
if it is feasible to control operation of the main vehicle so that ETAM=ETA2+DELAYM, determining if ETA3=0;
if ETA3=0, controlling operation of the main vehicle so that ETAM=ETA2+DELAYM;
if ETA3 is non-zero, then determining if |ETA3−ETAM|>=DELAYM;
if |ETA3−ETAM|>=DELAYM, controlling operation of the main vehicle so that ETAM=ETA2+DELAYM; and
if |ETA3−ETAM| is not >=DELAYM or it is infeasible to control operation of the main vehicle so that ETAM=ETA2+DELAYM, controlling operation of the main vehicle so that ETAM>=ETA3+DELAYM.

14. The method of claim 10, wherein the step of controlling operation of the main vehicle comprises steps of:
setting ETAM=ETA3+DELAYM;
determining if it is feasible to control operation of the main vehicle so that ETAM=ETA3+DELAYM;
if it is feasible to control operation of the main vehicle so that ETAM=ETA3+DELAYM, controlling operation of the main vehicle so that ETAM=ETA3+DELAYM; and
if it is infeasible to control operation of the main vehicle so that ETAM=ETA3+DELAYM, controlling operation of the main vehicle so that ETAM >ETA3+DELAYM.

15. A non-transitory computer-readable medium for controlling operation of a main vehicle and storing instructions that when executed by a processor cause the processor to control operation of the main vehicle while approaching an intersection so that the main vehicle stops near the intersection non-simultaneously with all intersecting vehicles.

16. The computer-readable medium of claim 15, further storing instructions that when executed by the processor cause the processor to:
estimate an estimated time of arrival (ETA) of each detected intersecting vehicle; and
arrange ETAs of all detected intersecting vehicle(s) in projected order of arrival.

17. The computer-readable medium of claim 16, further storing instructions that when executed by the processor cause the processor to:
determine if it is feasible to control operation of the main vehicle so that ETA1−ETAM=DELAYM;
if it is feasible to control operation of the main vehicle so that ETA1−ETAM=DELAYM, control operation of the main vehicle so that ETA1−ETAM=DELAYM; and
if it is not feasible to control operation of the main vehicle so that ETA1−ETAM=DELAYM, control operation of the main vehicle so that ETAM−ETA1>=DELAYM.

18. The computer-readable medium of claim 16, further storing instructions that when executed by the processor cause the processor to:
set ETAM=ETA1+DELAYM;
determine if it is feasible to control operation of the main vehicle so that ETAM=ETA1+DELAYM;
if it is feasible to control operation of the main vehicle so that ETAM=ETA1+DELAYM, determine if ETA2=0;
if ETA2=0, control operation of the main vehicle so that ETAM=ETA1+DELAYM;
if ETA2 is non-zero, determine if |ETA2−ETAM|>=DELAYM;
if |ETA2−ETAM|>=DELAYM, control operation of the main vehicle so that ETAM=ETA1+DELAYM; and
if |ETA2−ETAM| is not >=DELAYM or it is infeasible to control operation of the main vehicle so that ETAM=ETA1+DELAYM, control operation of the main vehicle so that ETAM>=ETA2+DELAYM.

19. The computer-readable medium of claim 16, further storing instructions that when executed by the processor cause the processor to:
set ETAM=ETA2+DELAYM;
determine if it is feasible to control operation of the main vehicle so that ETAM=ETA2+DELAYM;
if it is feasible to control operation of the main vehicle so that ETAM=ETA2+DELAYM, determine if ETA3=0;
if ETA2=0, control operation of the main vehicle so that ETAM=ETA2+DELAYM;
if ETA2 is non-zero, determine if |ETA3−ETAM|>=DELAYM;
if |ETA3−ETAM|>=DELAYM, control operation of the main vehicle so that ETAM=ETA2+DELAYM; and
if |ETA3−ETAM| is not >=DELAYM or it is infeasible to control operation of the main vehicle so that ETAM=ETA2+DELAYM, control operation of the main vehicle so that ETAM>=ETA3+DELAYM.

20. The computer-readable medium of claim 16, further storing instructions that when executed by the processor cause the processor to:
set ETAM=ETA3+DELAYM;
determine if it is feasible to control operation of the main vehicle so that ETAM=ETA3+DELAYM;
if it is feasible to control operation of the main vehicle so that ETAM=ETA3+DELAYM;
control operation of the main vehicle so that ETAM=ETA3+DELAYM; and
if it is infeasible to control operation of the main vehicle so that ETAM=ETA3+DELAYM, control operation of the main vehicle so that ETAM >ETA3+DELAYM.
